(19) United States
(12) Patent Application Publication
(10) Pub. No.: US 2016/0371258 A1
(43) Pub. Date: Dec. 22, 2016

(54) SYSTEMS AND METHODS FOR CREATING UNIFIED DOCUMENT LISTS

(71) Applicant: Microsoft Technology Licensing, LLC, Redmond, WA (US)

(72) Inventors: Patrick Gan, Salem, MA (US); Manoj Sharma, Winchester, MA (US)

(73) Assignee: Microsoft Technology Licensing, LLC, Redmond, WA (US)

(21) Appl. No.: 14/745,685

(22) Filed: Jun. 22, 2015

(51) Int. Cl. G06F 17/30

(52) U.S. Cl. CPC G06F 17/30011; G06F 17/30132; G06F 17/30203; G06F 17/30554; G06F 17/3053; G06F 17/30106

(57) ABSTRACT

Systems and methods for creating a unified list of relevant documents are provided. More specifically, the systems and methods are able to access every known client account and pull documents from each of these accounts even if the accounts include more than one file hosting server and/or more than one account on a single file hosting server to create a unified document list. Further, the systems and methods are able to pull the most relevant documents from each of the client's accounts. Further, the systems and methods allow the unified document list to be sorted into multiple views via a sort option and/or to search for at least one document using received text from a search option.

### BACKGROUND

A most recently used (MRU) document list contains links to documents that a user has recently opened, modified, edited and/or saved. The MRU document list is a convenient mechanism for accessing a document that was recently used.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to systems and methods for creating a unified list of relevant documents. More specifically, the systems and methods disclosed herein are able to access every known client account and pull documents from each of these accounts even if the accounts include more than one file hosting server and/or more than one account on a single file hosting server to create a unified document list. More specifically, the systems and methods disclosed herein are able to pull the most relevant documents from each of the client's accounts. Further, the systems and methods disclosed herein allow the unified document list to be sorted into multiple views via a sort option and/or to search for at least one document using received text from a search option. Accordingly, the systems and methods disclosed herein provide for a more accurate, a more reliable, and a more comprehensive list of utilized documents accessed by the user. Further, the systems and methods disclosed herein provide for more accurate, more reliable, and more comprehensive options for finding documents within the unified list. Additionally, the systems and methods disclosed herein improve a user's ability to find desired documents by displaying the most relevant documents as opposed to just the most recently used. As such, the systems and methods disclosed herein reduce or prevent unwanted documents from being added to the unified list improving the usability of the documents in the unified list and improving user interactions with the device.

One aspect of the disclosure is directed to a system. The system includes at least one processor and a memory. The memory encodes computer executable instruction that, when executed by the at least one processor, cause the at least one processor to perform a method for creating a unified list of relevant documents. The method includes retrieving from an identity cache a plurality of identities accessible by a user. The method further includes accessing a first file hosting service associated with a first identity in the plurality of identities utilizing the first identity and accessing a second file hosting service associated with a second identity in the plurality of identities utilizing the second identity. The method also includes retrieving first documents from the first file hosting service, retrieving second documents from the second file hosting service, and retrieving third documents form a local drive on the system. Further, the method includes analyzing the first documents, the second documents, and the third documents for relevance to find relevant documents and creating the unified list of relevant documents from the first documents, the second documents, and the third documents based on the relevant documents. Additionally, the method includes displaying the unified list of relevant documents to the user in a first location.

Another aspect of the disclosure includes a system. The system includes an identity system, a retrieval system, an analysis system, and a display system. The identity system retrieves from an identity cache a plurality of identities accessible by a user and accesses a plurality of file hosting service utilizing the plurality of identities. Each file hosting service is associated with at least one identity in the plurality of identities. The retrieval system retrieves first documents from the plurality of file hosting service and retrieves second documents from a local drive on the system. The analysis system analyzes the first documents and the second documents for relevance to find relevant documents and creates a unified list of relevant documents from the first documents and the second documents based on the relevant documents. The displays the unified list of relevant documents to the user in a first location.

Yet another aspect of the disclosure includes a method for creating a unified list. The method includes accessing a plurality of file hosting services utilizing a plurality of identities of a user and aggregating a plurality of documents from each of the plurality of file hosting services and from a local drive on a system to create a combined list of documents. Each file hosting service is associated with at least one identity in the plurality of identities. The method further includes analyzing the combined list to locate relevant documents, creating a unified list that includes the relevant documents, and displaying the unified list in a first location on a user interface. Additionally, the method includes providing a sort option for sorting the unified list and providing a search option for searching the unified list for at least one document. The sort option including a plurality of views.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive aspects are described with reference to the following Figures.

FIG. 1 illustrates an exemplary system for creating a unified list of relevant documents and other components the system interacts with, according to an example aspect.

FIG. 2 illustrates an exemplary system for creating a unified list of relevant documents and other components the system interacts with, according to an example aspect.

FIG. 3 illustrates an exemplary screen shot of an application displaying a unified list of relevant documents, according to an example aspect.

FIG. 4 illustrates an exemplary screen shot of an application displaying a unified list of relevant documents, according to an example aspect.

FIG. 5 illustrates an exemplary screen shot of a touch user interface running an application displaying a unified list of relevant documents, according to an example aspect.

FIG. 6 illustrates an exemplary screen shot of a touch user interface running an application displaying a unified list of relevant documents, according to an example aspect.

FIG. 7 illustrates an exemplary screen shot of an application displaying a unified list of relevant documents, according to an example aspect.

FIG. 8 illustrates an exemplary screen shot of an application displaying a unified list of relevant documents, according to an example aspect.

FIG. 9 illustrates an exemplary screen shot of a touch user interface running an application displaying a unified list of relevant documents, according to an example aspect.

FIG. 10 is a flow diagram illustrating an example of a method for creating a unified list of relevant documents, according to an example aspect.

FIG. 11 is a block diagram illustrating example physical components of a computing device with which aspects of the disclosure may be practiced.

FIGS. 12A and 12B are simplified block diagrams of a mobile computing device with which aspects of the present disclosure may be practiced.

FIG. 13 is a simplified block diagram of a distributed computing system in which aspects of the present disclosure may be practiced.

FIG. 14 illustrates a tablet computing device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

Today a user may utilize several different web-accessible file hosting servers and may have several different accounts on each of these different web-accessible file hosting servers. The user may remotely store different documents on each of these file hosting servers and on each of their accounts for a file hosting server that is accessible through a web browser. The user may access the documents stored on the file hosting server through a web-enabled computing device. Typically, a computing device utilized by the user will document a MRU document list containing documents the user used recently from only one file hosting server, and other local locations, while logged onto the computing device. As such, the MRU document list in the computing device may not accurately reflect the most recently used documents of the user that were accessed in other file hosting servers and/or that were accessed by the user from another computing device.

As discussed above, the current MRU document list system pull documents from the local device and/or from any file hosting server under the account that the user is currently logged into. However, none of these current systems are able to pull documents from more than one file hosting server at a time and/or from multiple accounts on a single file hosting server that the client is not logged into along with locally stored documents. Further, none of these current systems are able to pull the most relevant document regardless of whether they were the most recently used.

The systems and methods disclosed herein are able to access every known client account and pull documents from each of these accounts even if the accounts include more than one file hosting server and/or more than one account on a single file hosting server to create a unified document list. More specifically, the systems and methods disclosed herein are able to pull the most relevant documents from each of the clients' accounts. Further, the systems and methods disclosed herein allow the unified document list to be sorted into multiple views via a sort option and/or searched to find at least one document using received text from a search option. Accordingly, the systems and methods disclosed herein for creating a unified document list provide for a more accurate, a more reliable, and a more comprehensive list of utilized documents accessed by the user. Further, the systems and methods disclosed herein for creating a unified document list provide for more accurate, more reliable, and more comprehensive options for finding documents within the unified list. Additionally, the systems and methods disclosed herein for creating a unified document list improve a user's ability to find desired documents by displaying the most relevant documents as opposed to just the most recently used. As such, the systems and methods disclosed herein for creating a unified document list reduce or prevent unwanted documents from being added to the unified list improving the usability of the documents in the unified list and improving user interactions with the device.

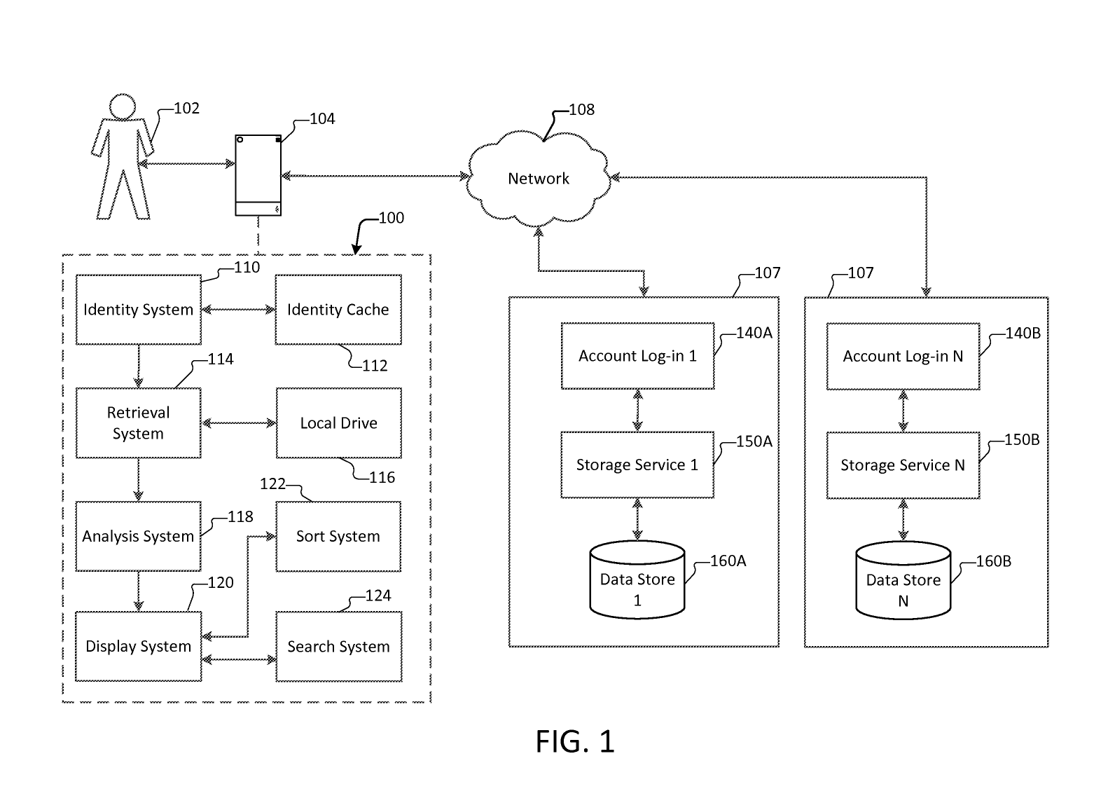

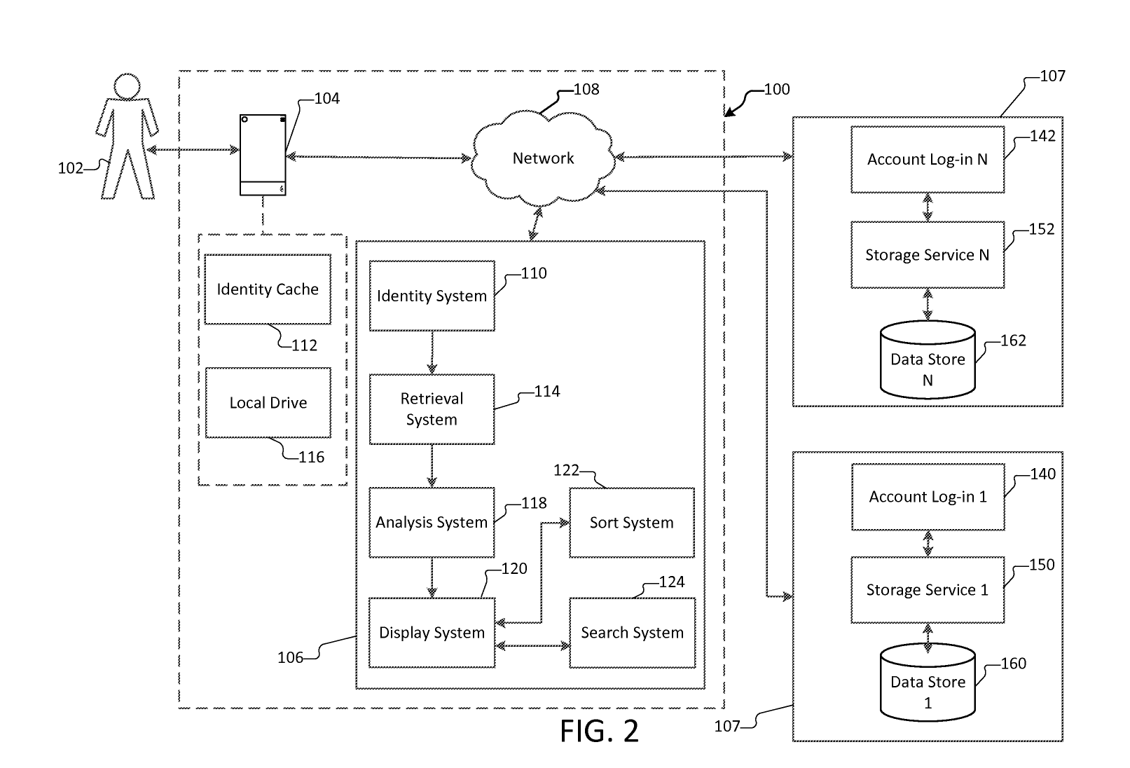

Referring now to the drawings, in which like numerals represent like elements through the several figures, aspects of the present disclosure and the exemplary operating environment will be described. With reference to FIGS. 1 and 2, aspects of a system 100 for creating a unified document list are illustrated. In some aspects, the system 100 may be implemented on a client computing device 104, as illustrated in FIG. 1. The client computing device 104 may be a handheld computer having both input elements and output elements. Alternatively, the client computing device 104 may be non-mobile computer having both input elements and output elements. The client computing device 104 may be any suitable computing device for implementing the system 100 for creating a unified document list with a unified document application. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for implementing the system 100 creating a unified document list with a unified document application may be utilized.

In some aspects, the system 100 may be implemented on a server computing device 106, as illustrated in FIG. 2. The server computing device 106 may provide data to and from the client computing device 104 through a network 108. In aspects, the system 100 may be implemented on more than one server computing device 106, such as a plurality of server computing devices 106. As discussed above, the server computing device 106 may provide data to and from the client computing device 104 through the network 108. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As illustrated in FIGS. 1 and 2, the system 100 may include an identity system 110, a retrieval system 114, an analysis system 118, and a display system 120. In some aspects, the display system 120 includes a sort system 122 and a search system 124. In alternative aspects, the sort system 122 and the search system 124 are separate and distinct components from the display system 120 as illustrated in FIGS. 1 and 2. The system 100 may further include an identity cache 112 and a local storage 116 also referred to herein as a local drive 116. The various components may be implemented using hardware, software, or a combination of hardware and software. The system 100 may be configured to create a unified list of relevant documents. In this regard, the display system 120 may be configured to display the unified list. In some aspects, the display system includes a user interface component. In one example, the user interface component is a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component is a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

As discussed above, the system 100 is configured to create a unified list of relevant documents. In some aspects, the system 100 is a client computing device 104, a server computing device 106, and/or a unified document application running on a client computing device 104 and/or server computing device 106. In one example, the unified document application may include any application suitable for creating a unified document list.

As discussed above, system 100 includes an identity system 110. The identity system 110 retrieves from an identity cache 112 a plurality of identities accessible by a user 102. The identity cache 112 is memory that stores one or more identities. An identity includes log-in information, such as a log-in identification (referred to herein as a “log-in ID”) and an associated password, for an account on a file hosting service. The identity may further include the specific file hosting service associated with the log-in information. Each account on the same or different file hosting service will require its own log-in information to access information, such as documents, stored in that account for the file hosting service. In some aspects, the user 102 enters or inputs the identities or log-in information for each account into the identity cache. In other aspects, the identity cache automatically stores identities of the user 102 upon use an identity by the user 102. In alternative aspects, the identity cache 112 receives user identities from user input and from automatic retrieval of an identity by the identity caches 112 upon use of the identity by a user 102. In some aspects, the identity cache 112 will store identities from multiple file hosting services and/or identities for multiple accounts on the same file hosting service. In these aspects, the identity system 110 retrieves identities from multiple file hosting services and/or identities for multiple accounts on the same file hosting service.

The identity system 110 may continuously monitor the identity cache 112 for new identities. In alternative aspects, the identity system 110 monitors the identity caches 112 after a predetermined amount of time or after a predetermined event. The identity system 110 or the identity cache 112 may be located on a server computing device 106 or on the client computing device 104. In some aspects, the identity system 110 and the identity cache 112 are both located on the client computing device 104 or the server computing device 106. In other aspects, the identity system 110 and the identity cache 112 are located on different computing devices, such as the identity cache 112 on the server computing device 106 and the identity system 110 on the client computing device 104.

Once the identity system 110 has retrieved the identities from the identity cache 112, the identity system 110 accesses each file hosting service 150 associated with an identity utilizing the log-in information from the identity. The file hosting services 150 are stored on server computing devices 107 that are separate from system 100. In some aspects, the file hosting service 150 is accessed on these server computing devices 107 through an account log-in 140. The identity system 110 of system 100 communicates with these server computing devices 107 through the network 108. As such, the server computing device 107 may provide data to and from the system 100 through the network 108.

In one example, the file hosting service 150 may be configured to store, manage, and access data and/or information associated with the user account. For example, the file hosting service 150 may store one or more files in a data store 160. In one example, data store 160 may be part of and/or located at the file hosting service 150. In another example, data store 160 may be a separate component and/or may be located separate from file hosting service 150. It is appreciated that although only two server computing devices 107 are illustrated in FIGS. 1 and 2, the system 100 may interact with any number of server computing devices 107 with a plurality of file hosting service 150 and a plurality of data stores 160. In some cases, the server computing device 107 may include a plurality of file hosting service 150 and a plurality of data stores 160. In one example, the file hosting service 150 may be a cloud storage service such as OneDrive, SharePoint, Google Drive, Facebook, Instagram, twitter, Dropbox, and the like.

The identity system 110 enters the user's log-in ID and password from the identity into the account log-in 140 of the file hosting service 150. Once logged-in to an account on the file hosting service 150, information stored on the data store 160 for that account on the file hosting service 150 can be accessed. As such, in some aspects, the identity system 110 accesses a plurality of different file hosting services 150A . . . 150N and/or multiple accounts on the same file hosting service 150.

The retrieval system 114 retrieves documents from each account accessed by the identity system. Accordingly, in some aspects, documents are retrieved by the retrieval system 114 from a plurality of file hosting services and/or from a plurality of accounts on the same file hosting service. Additionally, the retrieval system 114 retrieves documents from the local drive 116 on the system 100. The local drive 116 or the retrieval system 114 may be located on a client computing device 104 and/or on a server computing device 106. In some aspects, the retrieval system 114 combines all of the gathered or retrieved documents to form a combined list of documents. A document as utilized herein refers to any file saved or stored by a specific application. For example, a document may be a file from any of the following applications: a digital assistant application; a voice recognition application; an email application; a social networking application; a collaboration application; an enterprise management application; a messaging application; a word processing application; a spreadsheet application; a database application; a presentation application; a contacts application; a gaming application; an e-commerce application; an e-business application; a transactional application; exchange application; a calendaring application; and etc. In some aspects, the retrieval system sends the retrieved or gathered documents (or the combined list) to the analysis system 118. In other aspects, the analysis system 118 retrieves the gathered documents (or the combined list) from the retrieval system 114.

The analysis system 118 analyzes the documents retrieved by the retrieval system 114 or the combined list for relevance. Based on this analysis, the analysis system 118 selects the relevant documents from the combined list and creates a unified list of relevant documents. The relevance of the documents is determined based on one or more factors. In some aspects, the factors may be updated, selected, and/or modified by a user 102. In some aspects, the relevance is determined based on one or more of the following factors: the most recently used documents, pinned documents, current trending documents, documents most recently provided but not accessed by the user, calendar information of the user, or a previous unified document list. Each of these relevance factors has a threshold. However, any suitable factors for determining the relevance of a document to a user may be utilized by analysis system 118. If the analysis system 118 of system 100 determines that a document meets one or more of the factor thresholds, the analysis system 118 adds the document to the unified list. If the analysis system 118 of system 100 determines that a document does not meet all of the factor thresholds or a predetermined number or grouping of the factor thresholds, the analysis system 118 does not add the document to the unified list.

In some aspects, the MRU documents are considered as part of the relevancy determination by analysis system 118. In these aspects, the analysis system 118 may monitor when a new file associated with an application is selected and created and when an already stored document is modified, such as edited, renamed, moved, and etc. on the local drive of the system 100 or on the file hosting service 150 at the server computing device 107. The time stamp of this activity is compared to a threshold to determine if the document is relevant. In some aspects, the threshold may be based on the time stamps of the other documents to determine the most recently utilized documents by the analysis system 118.

In some aspects, pinned documents are considered as part of the relevancy determination by analysis system 118. The analysis system 118 reviews a pin status of a document to determine if the document is pinned or unpinned. A document is pinned when it was selected or highlighted by the user 102. In some aspects, analysis system 118 considers the pinning of any document enough to make the document relevant and it is added to the unified list by the analysis system 118. In other aspect, the pinned document must meet additional thresholds, such a timing threshold. For example, pinned documents that have not been used by the user in over two years may not meet the pin threshold and are therefore considered not relevant to the user and they are not added to the unified list by the analysis system 118.

Unlike previously utilized MRU documents systems that focus on the documents that were the most recently pinned, opened, saved, or modified by the user, system 100 includes documents in the unified list that were provided to the user 102 but were never opened, saved, or modified by the user if the analysis system 118 of system 100 determines that the document is relevant to the user. In some aspects, calendar information of the user is considered as part of the relevancy determination by analysis system 118. For example, the analysis system 118 may present a document that has never been opened by the user 102, but is attached to a meeting invitation in the user's calendar scheduled to occur in the next few minutes. Even though the document has never been opened, the document is associated with calendar information that meets a timing threshold for relevance.

In some aspects, current trending documents are considered as part of the relevancy determination by analysis system 118. In another example, a video that is trending on the user's Facebook page that the user has never viewed or opened is presented on the unified list because it is considered to be relevant to the user based on its trending status. For example, the video may meet a threshold of being reposted a certain number of times or because it received a certain amount of likes to be considered relevant by the analysis system 118 and added to the unified list.

In some aspects, documents most recently provided but not accessed by the user are considered as part of the relevancy determination by the analysis system 118. In an additional example, two documents received within the last hour on the user's work email account that the user has never viewed or opened are presented on the unified list by the analysis system 118. The analysis system 118 may determine that documents meet an importance threshold since they were received on a work account and meet an additional timing threshold since they were received within the last three hours. As such, the analysis system 118 adds the documents to the unified list even though they have not been used by or viewed by the user 102.

In some aspects, a previous unified document list is considered as part of the relevancy determination by the analysis system 118. In another example, a document received on the user's personal email that has the same title as a document on the current unified list that was edited by the user within the last 24 hours is considered relevant by the analysis system 118 and added to the unified list. In this aspect, because the document meets a similarity percentage to a document on the current unified list and met an additional timing threshold, the analysis system 118 determined that the document is relevant to the user and added the document to the unified list.

While several different thresholds are provided above for each of the various relevancy factors, these thresholds are exemplary only and are not meant to be limiting. Any suitable threshold for determine relevancy of documents for the factors listed above as would be known by a person of skill in the art may be utilized.

In some aspects, the analysis system 118 sends the unified list to the display system 120. In other aspects, the display system 120 retrieves the unified list from the analysis system 118.

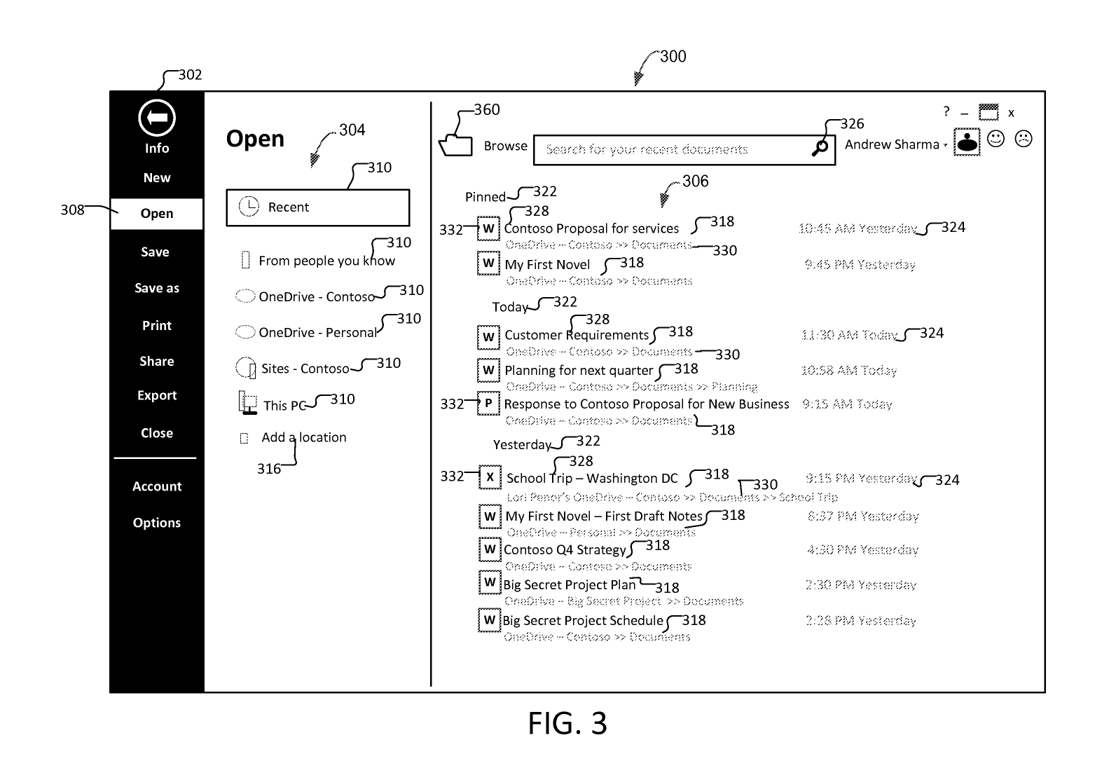

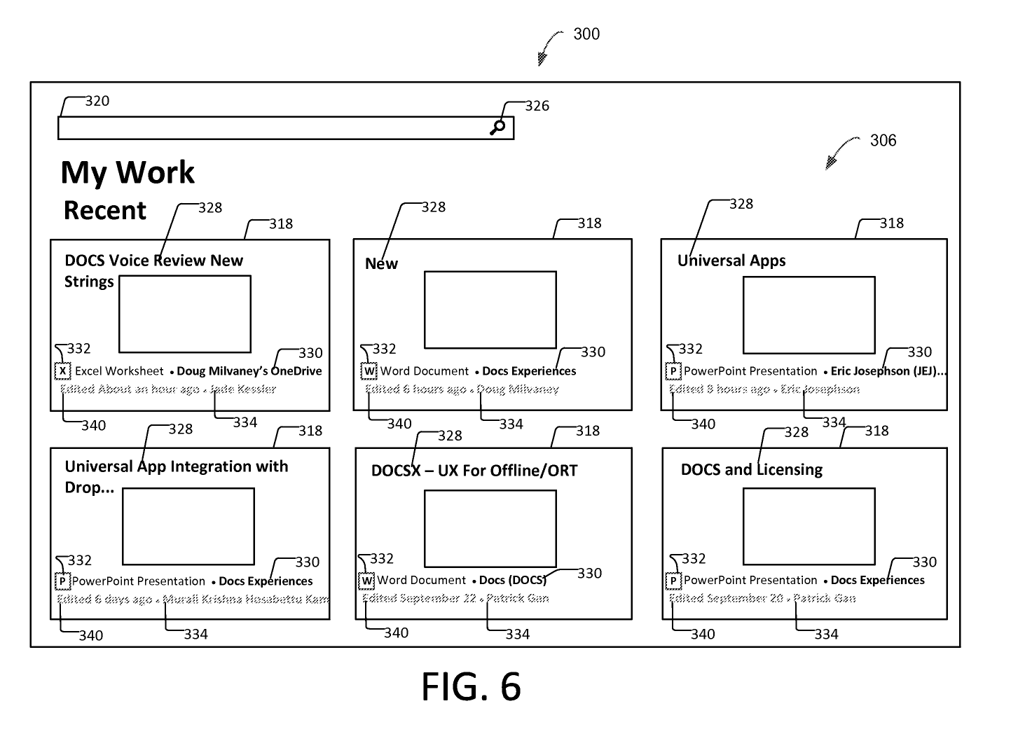

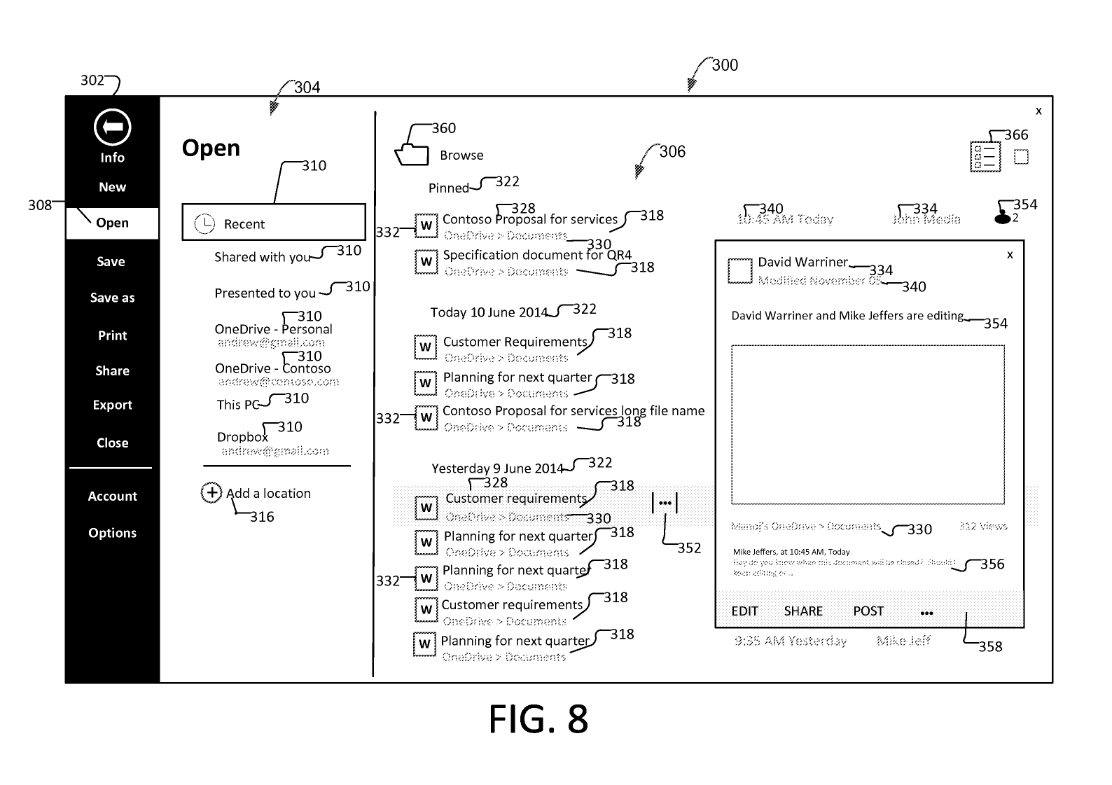

The display system 120 displays the unified list of relevant documents to the user in at least one location. The unified list may be displayed in numerous different views. FIGS. 3-8 illustrate different example screen shots 300 of the display of different unified lists of relevant documents 318. In some aspects, the unified list 306 is displayed at a first location on a start page upon logging into system 100, as illustrated in FIG. 6. In additional aspects, the unified list 306 is displayed at a second location on an open document menu option 308 within a specific application, as illustrated in FIGS. 3-5 and 7-9. For example, a menu 302 showing that an open document menu option 308 has been selected is illustrated in FIGS. 3-5 and 7-9.

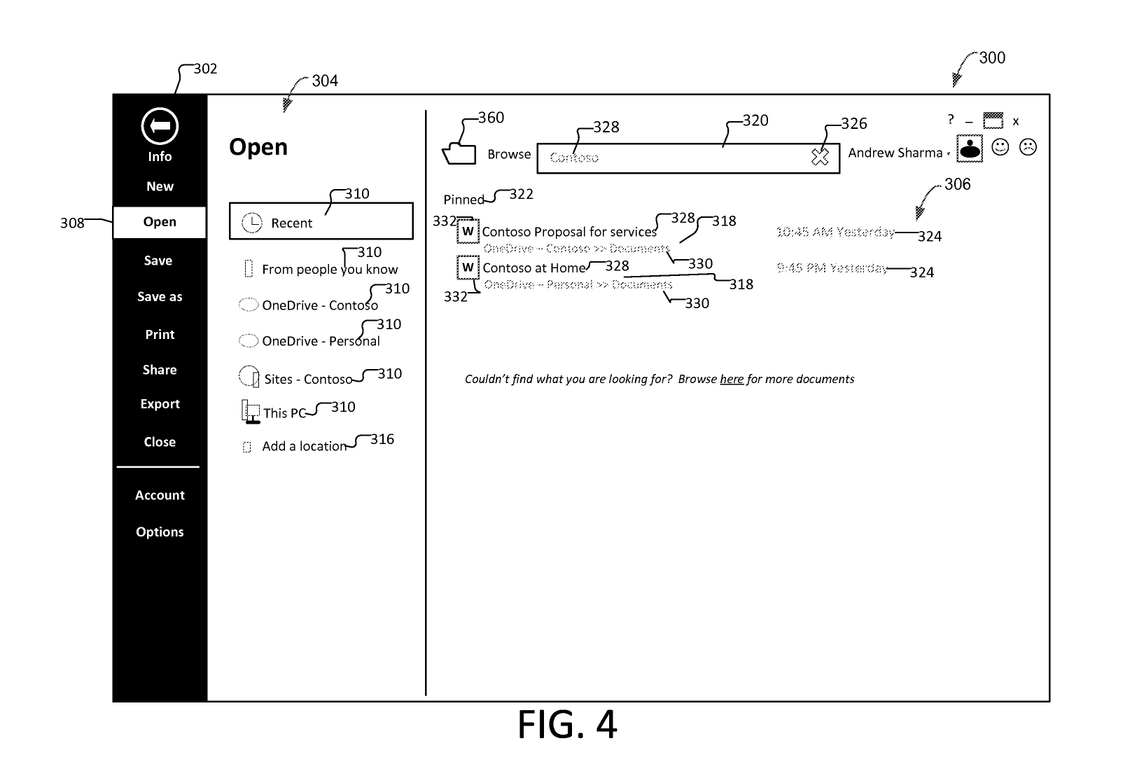

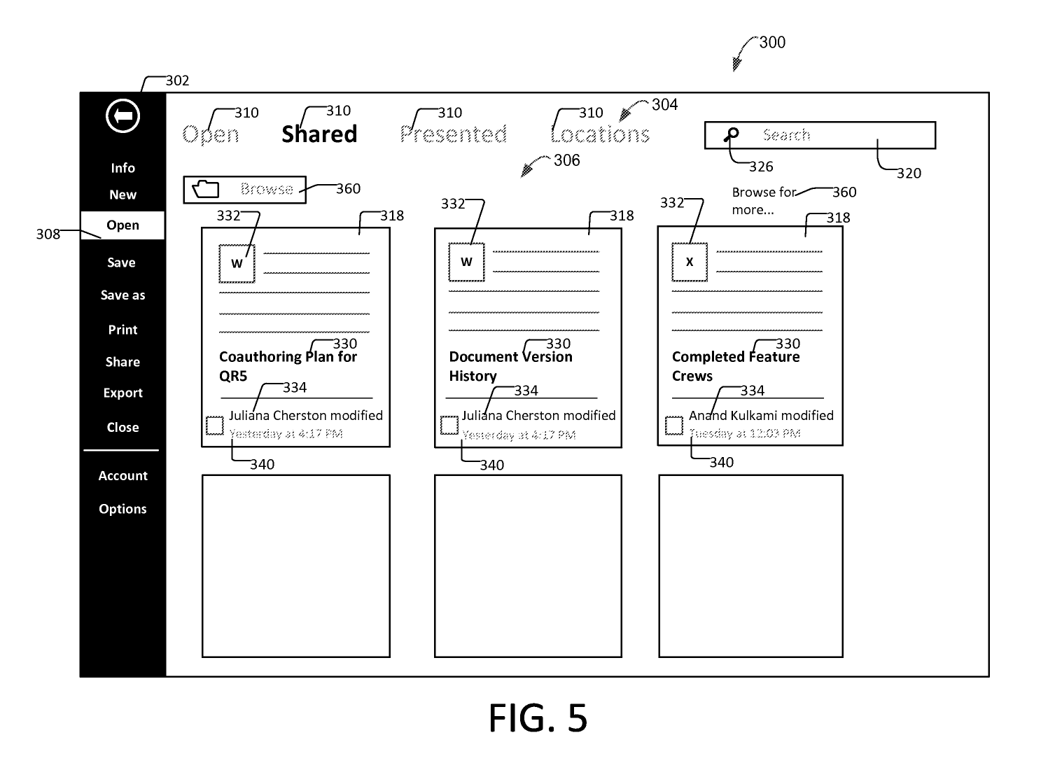

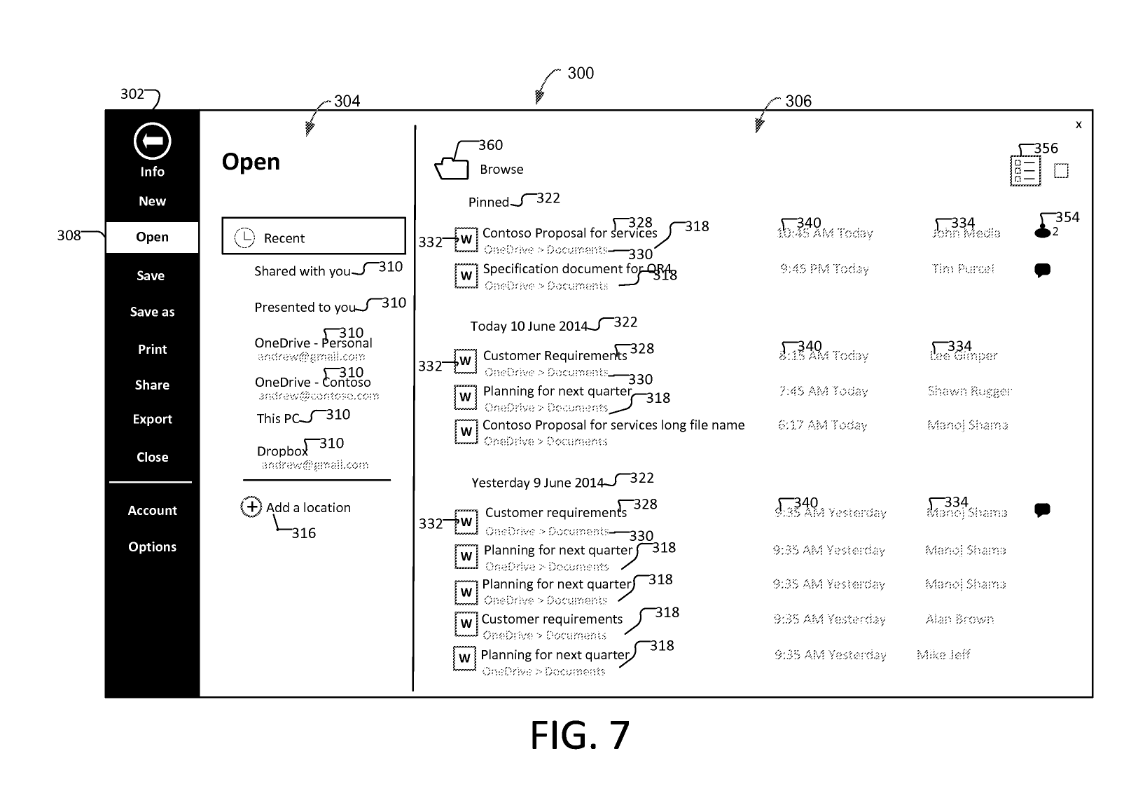

The relevant documents 318 within the unified list 306 may be displayed in different modes, such as icons, a list, details, tiles, or content. The user 102 may select the mode of display with a mode switch 366 as illustrated in FIGS. 7-9. For example, the documents 318 are shown as content in FIG. 3, as details in FIG. 4, and as icons in FIGS. 5 & 6.

For each document 318, the unified list 306 displays one or more pieces of information about the document. This information varies based on the selected mode by the user. For example, the unified list may display the name or title 328 of the document, the application 332 of the document, the store location 330 of the document, the user time stamp 324 of the document, the author 342 of the document, the last person to modify 340 the document, the last person time stamp 344, details 352 about the document, comments 356 associated with a document, share options 358, and/or activity 354 (such as comments 352, edits, viewers, and/or etc. of a document) associated with the document. As used herein, a “person” includes the user or other clients that may have used, edited, created, viewed, and/or modified a document. In some aspects, the documents are organized by headings 322 within the unified list 306.

In some aspects, system 100 includes a sort system 122 and/or a search system 124. The sort system 122 and/or search system 124 may be part of the display system 120 or may be separate and distinct systems from the display system 120.

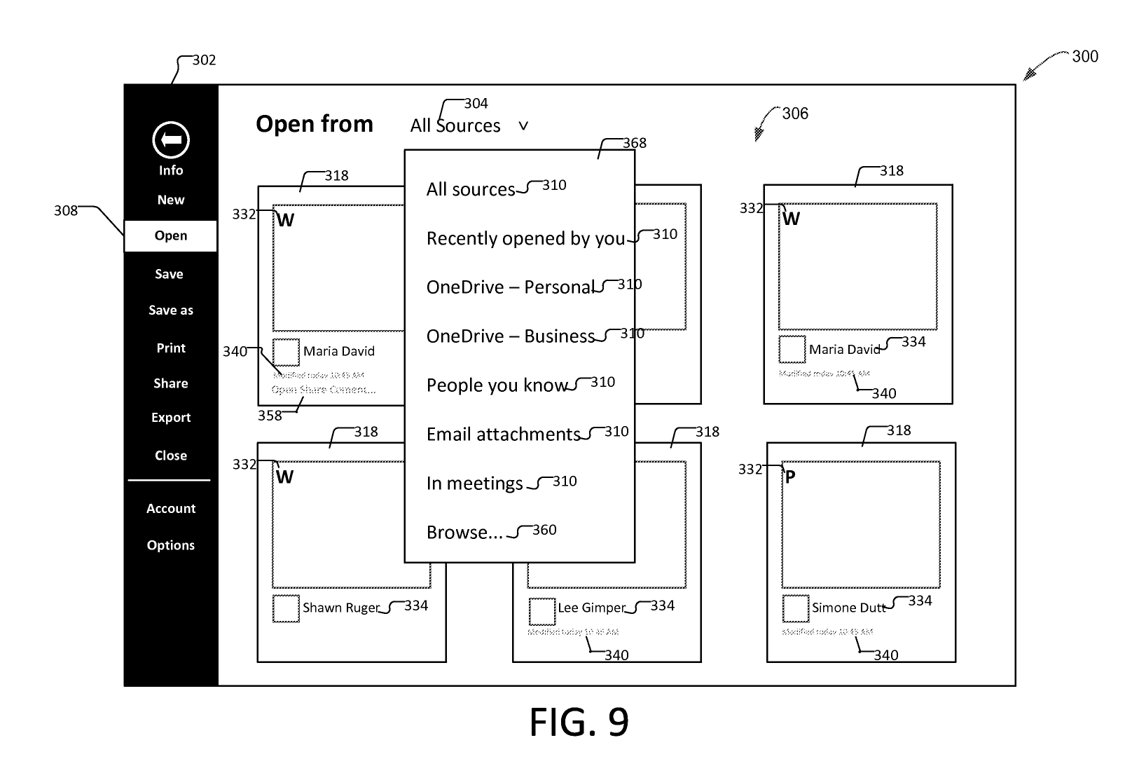

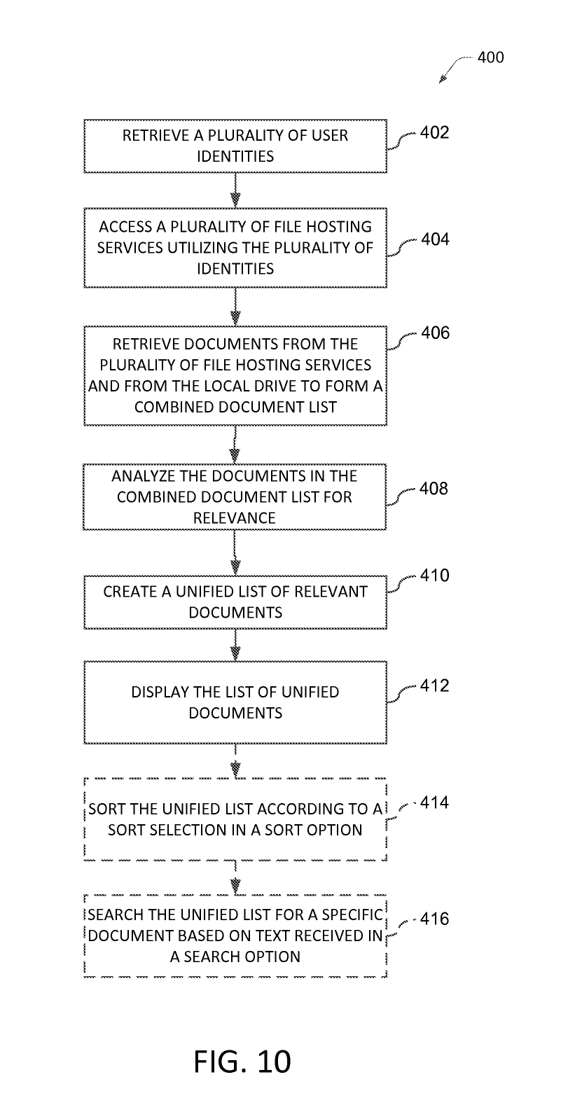

The sort system 122 allows a user to sort the documents 318 provided in the unified list 306 based on provided sort selections 310. The sort system 122 sorts the unified list 306 according to a received sort selection 310 in a sort option 304. The sort option 304 includes a plurality of views. For example, the sort option 304 may be in a list view as illustrated in FIGS. 3-4 and 7-8. In an alternative example, the sort option 304 may be in a menu view as illustrated in FIG. 5. In another example, the sort option 304 may be in a drop down menu as illustrated in FIG. 9.

The sort selection 310 may be any suitable parameter for sorting documents on the unified list. In some aspects, the sort selection 310 is one or more of the following selections: a most recently used, a pinned, a file location, a specific file location, an author, a specific author, a title, a modification date, a last edited by, a shared, email attachments, an application, a specific application, a meeting, relevance, or a presented selection. In some aspects, locations can be added to the sort features as illustrated by add location option 316 presented in FIGS. 3-4 and 7-8. In further aspects, the add location option 316 may further be utilized by the identity cache 112 to determine new identities associated with the user.

If the sort system 122 receives a most recently used sort selection by the user, the sort system 122 may sort the relevant documents in the unified list by user time stamp. As used herein “user time stamp” refers to the last time the user created, saved, modified, edited, and/or viewed a document. The sort system 122 may place documents without a user time stamp at or near the beginning or at or near the end of the unified list. In some aspects, the sort system 122 also sorts the relevant document by pinned documents in addition to the most recently utilized documents for display by the display system 120 in the unified list in response to receiving a most recently used sort selection by the user. The sort system 122 may place pinned documents at or near the beginning or at or near the end of the unified list. If the sort system 122 receives a modification sort selection by the user, the sort system 122 may sort the relevant documents in the unified list by last person time stamp. As used herein the “last person time stamp” refers to the last time the user or another client of the system created, saved, modified, edited, and/or viewed a document.

If the sort system 122 receives a pinned selection by the user, the sort system 122 filters the relevant documents, so that only the pinned documents remain on the unified list and are displayed by the display module 120. If the sort system 122 receives a file location selection by the user, the sort system 122 may filter the relevant documents so that they are sorted accordingly to file location for display by the display module 120 in the unified list. If the sort system 122 receives a specific file location selection by the user, the sort system 122 selects the relevant documents that are stored in the selected file location and then only these selected documents are displayed by the display module 120 in the unified list. If the sort system 122 receives an author selection by the user, the sort system 122 filters the relevant documents by author and then the display module 120 displays the sorted unified list. If the sort system 122 receives a specific author selection by the user, the sort system 122 may select documents from the relevant documents that are authored by the specific selected author and then only these selected documents are displayed by the display module 120 in the unified list.

If the sort system 122 receives a title selection by the user, the sort system 122 filters the relevant documents by title and then the display module 120 displays the sorted unified list. If the sort system 122 receives a last edited selection by the user, the sort system 122 sorts the relevant documents in the unified list by the last person who modified the document. If the sort system 122 receives a shared selection by the user, the sort system 122 selects the relevant documents that were shared with the user from another person and then only these selected documents are displayed by the display module 120 in the unified list. If the sort system 122 receives an email attachments selection by the user, the sort system 122 selects the relevant documents that were from email attachments and then only these selected documents are displayed by the display module 120 in the unified list. If the sort system 122 receives an application selection by the user, the sort system 122 may filter the relevant documents so that they are sorted accordingly to application for display by the display module 120 in the unified list. If the sort system 122 receives a specific application selection by the user, the sort system 122 selects the relevant documents that are in the specific application and then only these selected documents are displayed by the display module 120 in the unified list.

If the sort system 122 receives a meeting sort selection by the user, the sort system 122 selects the relevant documents that are from calendar items and then only these selected documents are displayed by the display module 120 in the unified list. If the sort system 122 receives a presented sort selection by the user, the sort system 122 selects the relevant documents that have been presented to other users, such as PowerPoint™ files, and then only these selected documents are displayed by the display module 120 in the unified list. If the sort system 122 receives a relevance sort selection by the user, the sort system 122 may filter the relevant documents so that they are sorted according to most or least relevant documents for display by the display module 120 in the unified list. For example, FIG. 6 illustrates a screen shot of a display screen showing a unified list sorted by relevance.

The search system 124 searches the unified list 306 for at least one document 318 utilizing text received from the user in a search option 326. In some aspects, the search option 326 is a search text box displayed at the top or bottom of the unified list as illustrated in FIGS. 3-7. In other aspects, the search option 326 is a search text box displayed upon selection, within a menu, or within a drop down menu. When the search system 124 of the system 100 receives text in the text box 320, the current unified list is searched for the entered text. Any documents found to contain the received text are displayed and any documents from the unified list that do not contain the received text are removed from the display by the display system 120 as illustrated by FIG. 4.

In some aspects, the document the user is looking for may not be presented in the unified list 306. As such, in some aspects, system 100 includes a browse option 360. The browse option 360 allows a user to pull additional relevant documents. Upon receiving a user selection of a browse option 360, the system 100 searches for additional relevant documents to user. For example, in some aspects, the unified list may include a list of 25 documents. In this example, an additional 25 relevant documents may be presented to the user upon receipt of a selection of a browse option. These additional relevant documents may be displayed in addition to the original unified list or may replace the original unified list. In some aspects, the browse option 360 is displayed as a selectable icon as illustrated in FIGS. 3-5, and 7-8. In other aspects, the browse option is provided in a drop down menu as illustrated in FIG. 9.

The unified list or the current unified list is the most recent list of relevant documents displayed to the user. The last unified list is the unified list displayed to the user prior to the most recently displayed unified list.

In some aspects, the system 100 continuously updates the unified list of relevant documents. In other aspects, the system 100 updates the unified list after a predetermined amount of time or after the occurrence of a set event. Further, in some aspects, system 100 updates the unified list regardless of whether the user is logged into the system 100 or not.

FIG. 4 illustrates a flow diagram conceptually illustrating an example of a method 400 for creating a unified list of relevant documents. In some aspects, method 400 is performed by the system 100 as described above. Method 400 is able to access every known client account and pull documents from each of these accounts even if the accounts include more than one file hosting server and/or more than on account on a single file hosting server to create a unified document list. Further, Method 400 is able to pull the most relevant documents from each of the clients' accounts and not just the most recently used documents. As such, method 400 provides for a more accurate, a more reliable, and a more comprehensive list of documents for the user. Further, method 400 creates a unified document list that provides for more accurate, more reliable, and more comprehensive options for finding documents within the unified list. Additionally, method 400 creates a unified document list that improve a user's ability to find desired documents by displaying the most relevant documents as opposed to just the most recently used. As such, method 400 creates a unified document list that reduces or prevents unwanted documents from being added to the unified list improving the usability of the documents in the unified list and improving user interactions with a device.

At operation 402, a plurality of identities accessible by a user retrieved from an identity cache. As discussed above, an identity includes log-in information, such as a log-in ID and an associated password, for an account on a file hosting service. The identity may further include the specific file hosting service associated with the log-in information. Each account on the same or different file hosting service will require its own log-in information to access information, such as documents, stored in that account for the file hosting service. In some aspects, operation 402 continuously monitors the identity cache for new identities. In other aspects, operation 402 monitors the identity cache for new identities at predetermined amounts of time or after a predetermined event.

At operation 404 a file hosting service associated with a retrieved identity is accessed utilizing the associated identity. In other words, operation 404 utilizes the log-in information in the identity to log into the associated file hosting service. Accordingly, in some aspects, at operation 404 a plurality of file hosting services are accessed utilizing the plurality of identities. Each file hosting service is associated with at least one identity in the plurality of identities. As such, in some aspects, at operation 404 a first file hosting service associated with a first identity in the plurality of identities is accessed utilizing the first identity and a second file hosting service associated with a second identity in the plurality of identities is accessed utilizing the second identity. In further aspects, at operation 404 a third file hosting service associated with a third identity in the plurality of identities may be accessed utilizing the third identity and/or the first file hosting service associated with a fourth identity in the plurality of identities may be accessed utilizing the fourth identity. In some aspects, the file hosting service is part of a separate server computing device and therefore, operation 404 communicates through a network to access the file hosting service. Once logged-in to an account on the file hosting service, information stored on the data store for that account on the file hosting service can be accessed. As such, in some aspects, a plurality of different file hosting services 150A . . . 150N and/or multiple accounts on the same file hosting service 150 are accessed during operation 404.

Documents from the file hosting services accessed during operation 404 and documents from a local drive on the system are retrieved during operation 406. In some aspects, a first set of documents from the plurality of file hosting service and a second set of documents from a local drive on a system are retrieved during operation 406. In some aspects, first documents from the a first file hosting service, second documents from a second file hosting service, and third documents form a local drive on the system are retrieved during operation 404. In some aspects, documents are gathered or retrieved from a plurality of file hosing services 150A . . . 150N. In some aspects, all of the gathered or retrieved documents are aggregated or combined to form a combined list of documents during operation 406.

At operation 408 documents retrieved by operation 406 are analyzed for relevance. In other words, the combined list of documents is analyzed for relevance during operation 408. In some aspects, first documents from a first file hosting service, second documents from a second file hosting service, and third documents from a local drive are analyzed for relevance at operation 408. The relevance of the documents is determined based on one or more factors during operation 408. In some aspects, the factors may be updated, selected, and/or modified by a user during operation 408. In some aspects, the relevance is determined, during operation 408, based on one or more of the following factors: the most recently used documents, pinned documents, current trending documents, documents most recently provided but not accessed by the user, calendar information of the user, or a previous unified document list. Each of these relevance factors has at least one threshold. If a document meets one or more of the factor thresholds, the document is selected during operation 408. If the document does not meet all of the factor thresholds or a predetermined number or grouping of the factor thresholds, the document is not selected at operation 408.

At operation 410 a unified list of relevant documents is created based on the analysis at operation 408. The documents from the combined list that are determined to be relevant based on the analysis performed during operation 408 are selected during operation 408. The selected documents are combined or aggregated to create a unified list of relevant documents during operation 410. In some aspects, the unified list of relevant documents is created from the first documents from a first client hosting service, from second documents from a second client hosting service, and from third documents from a local drive based on the analyzing of the first documents, the second documents, and the third documents. In other aspects, documents from a plurality of client hosting services and/or from multiple accounts from the same client hosting services are analyzed for relevance during operation 408 to create the unified list of relevant documents during operation 410.

At operation 412 the unified list of relevant documents is displayed at a first location on a user interface. The unified list may be displayed in numerous different views at operation 412. FIGS. 3-8 illustrate different example screen shots 300 of the display of the unified list of relevant documents. In some aspects, the unified list is displayed at a first location on a start page upon logging into a system at operation 412. In additional aspects, the unified list is displayed at a second location on an open document menu option within an application at operation 412. The relevant documents within the unified list may be displayed in different modes, such as icons, a list, details, tiles, or content at operation 412. The user may select the mode of display with a mode switch at operation 412.

Further, at operation 412 one or more pieces of information about each document may be displayed in the unified list. This information varies based on the selected mode by the user. For example, the unified list may display the name of the document, the application of the document, the store location of the document, the user time stamp of the document, the author of the document, the last person to modify the document, the last person time stamp, details about the document, comments associated with a document, share options, and/or activity associated with the document at operation 412. In some aspects, the documents are organized by headings within the unified list at operation 412.

In some aspects, method 400 further includes an operation 414 and/or an operation 416. At operation 414 the unified list is sorted according to a received sort selection in a sort option. In other words, a sort option for sorting the unified list is provided at operation 414. The sort option includes a plurality of views. For example, the sort option may be in a list view or in a menu view. In another example, the sort option may be in a drop down menu. As discussed above, the sort selection may be any suitable parameter for sorting documents on the unified list as would be known by a person of skill in the art. In some aspects, the sort selection is one or more of the following selections: most recently used, pinned, file location, specific file location, author, specific author, title, modification date, last edited by, shared, email attachments, application, specific application, meeting, relevance, or presented. In some aspects, locations can be added to the sort selection at operation 414.

At operation 416 the unified list for at least one document is searched utilizing text received from a user in a search option. In other words, a search option is provided for searching the unified list for at least one document at operation 416. When text in the text box is received, the current unified list is searched for the entered text at operation 416. Any documents found to contain the received text are displayed and any documents from the unified list that do not contain the received text are removed from the displayed unified list at operation 416.

Techniques for creating a unified list are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface

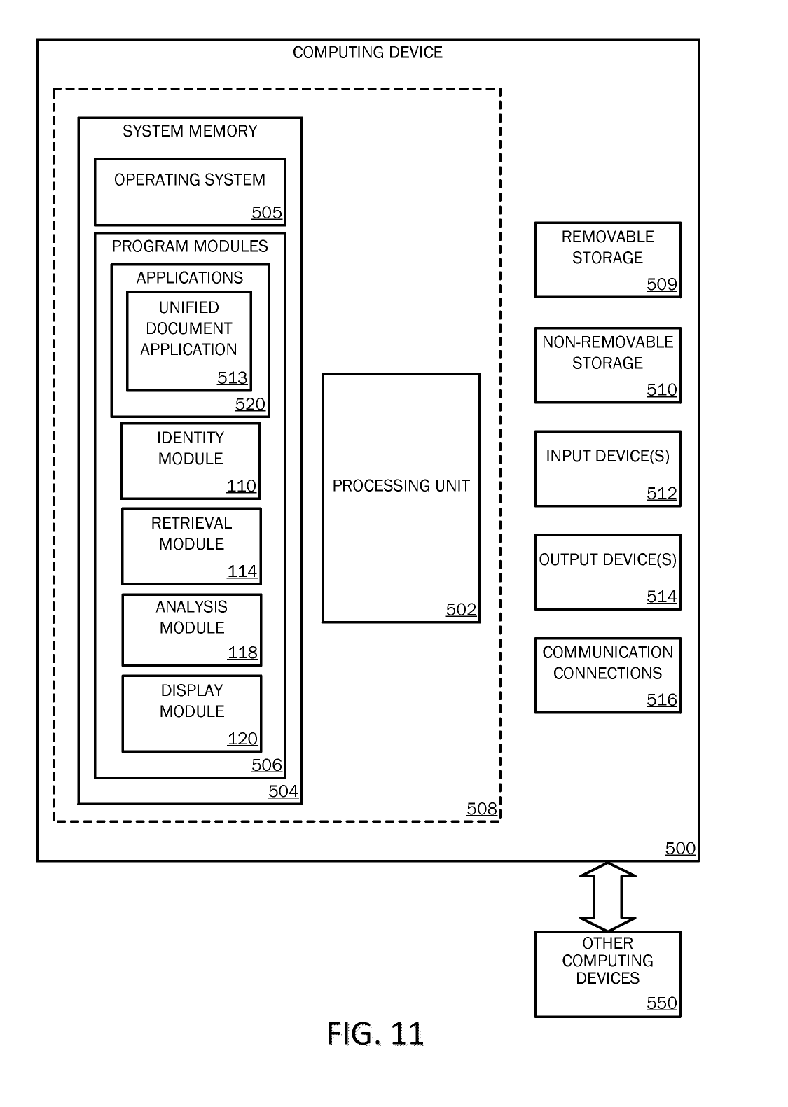

FIGS. 11-14 and the associated descriptions provide a discussion of a variety of operating environments in which aspects of the disclosure may be practiced. However, the devices and systems illustrated and discussed with respect to FIGS. 11-14 are for purposes of example and illustration and are not limiting of a vast number of computing device configurations that may be utilized for practicing aspects of the disclosure, described herein.

FIG. 11 is a block diagram illustrating physical components (e.g., hardware) of a computing device 500 with which aspects of the disclosure may be practiced. For example, an identity module 110, a retrieval module 114, an analysis module 118 and/or a display module 120 could be implemented by the computing device 500. In some aspects, the computing device 500 is a mobile telephone, a smart phone, a tablet, a phablet, a smart watch, a wearable computer, a personal computer, a desktop computer, a gaming system, a laptop computer, and/or etc. The computing device components described below may include computer executable instructions for an identity module 110, a retrieval module 114, an analysis module 118 and/or a display module 120 that can be executed to employ method 400 and implement portions of the system 100 disclosed herein. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications 520. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 11 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 11 by a removable storage device 509 and a non-removable storage device 510. For example, relevant documents obtained or selected by the retrieval module 114, the analysis module 118 and/or the display module 120 could be stored on any of the illustrated storage devices.

As stated above, a number of program modules and data files may be stored in the system memory 504. While executing on the processing unit 502, the program modules 506 and applications 520 (e.g., an identity module 110, a retrieval module 114, an analysis module 118, a display module 120, and/or unified document application 513) may perform processes including, but not limited to, performing method 400 as described herein. For example, the processing unit 502 may implement an identity module 110, a retrieval module 114, an analysis module 118 and/or a display module 120. Other program modules or applications that may be used in accordance with aspects of the present disclosure, and in particular to generate unified lists, may include a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a calendaring application, etc. In some aspects, the identity module 110, the retrieval module 114, the analysis module 118 and/or the display module 120 is performed by one of the above referenced applications.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Aspects of the disclosure may also be practiced using other technologies capable of performing logical operations such as, for example, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a microphone or other sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

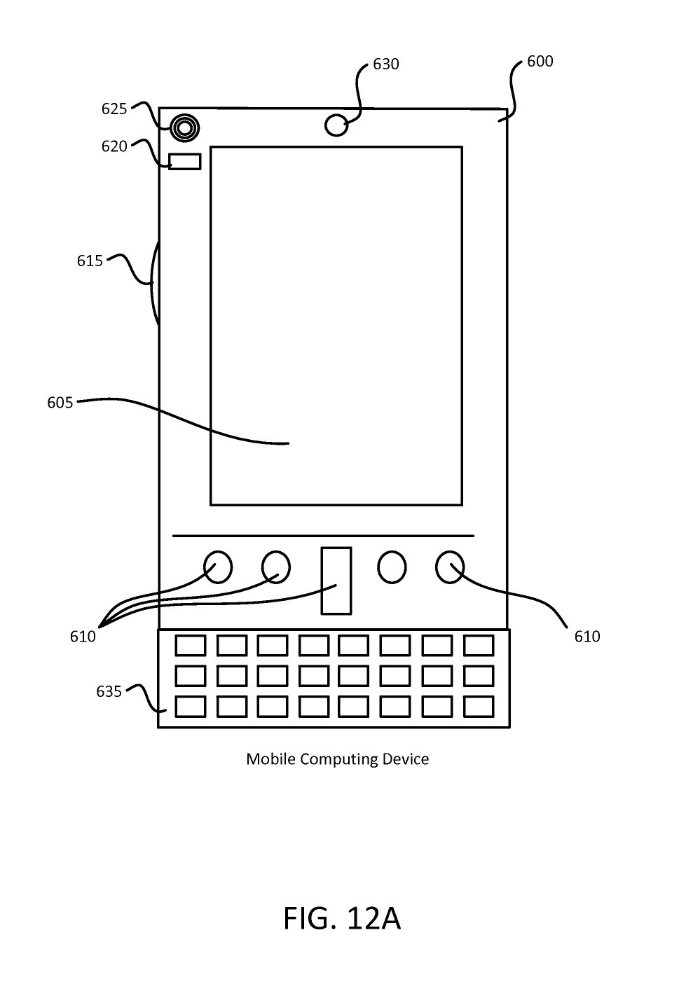

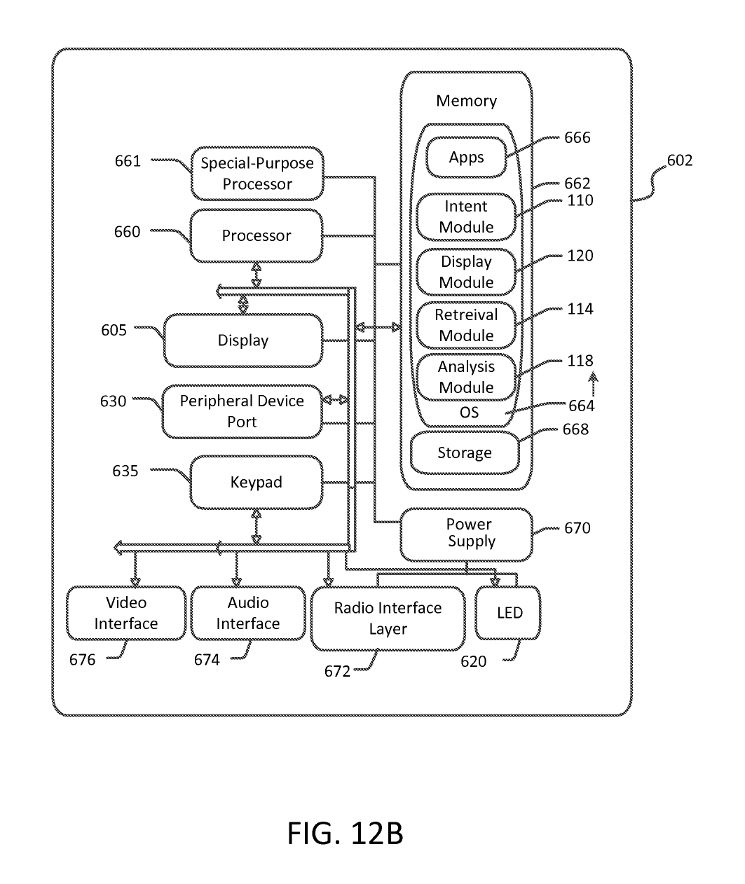

FIGS. 12A and 12B illustrate a mobile computing device 600, for example, a mobile telephone, a smart phone, a tablet, a phablet, a smart watch, a wearable computer, a personal computer, a desktop computer, a gaming system, a laptop computer, or the like, with which aspects of the disclosure may be practiced. With reference to FIG. 12A, one aspect of a mobile computing device 600 suitable for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display.

In addition to, or in place of a touch screen input device associated with the display 605 and/or the keypad 635, a Natural User Interface (NUI) may be incorporated in the mobile computing device 600. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various aspects, the output elements include the display 605 for showing a graphical user interface (GUI). In aspects disclosed herein, the various user unified lists could be displayed on the display 605. Further output elements may include a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 12B is a block diagram illustrating the architecture of one aspect of a mobile computing device. That is, the mobile computing device 600 can incorporate a system (e.g., an architecture) 602 to implement some aspects. In one aspect, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 and/or an identity module 110, a retrieval module 114, an analysis module 118 and/or a display module 120 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated aspect, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 12B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

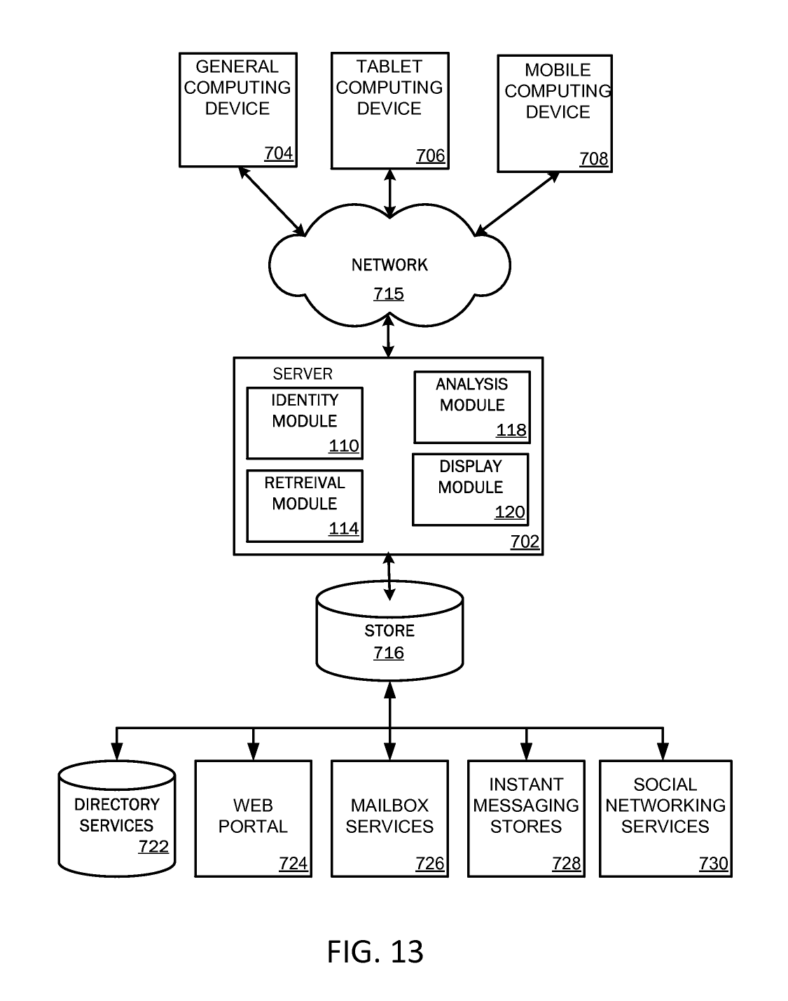

FIG. 13 illustrates one aspect of the architecture of a system for processing data received at a computing system from a remote source, such as a general computing device 704, tablet 706, or mobile device 708, as described above. Content displayed at server device 702 may be stored in different communication channels or other storage types. For example, various documents may be stored using a directory service 722, a web portal 724, a mailbox service 726, an instant messaging store 728, or a social networking site 730. By way of example, an identity module 110, a retrieval module 114, an analysis module 118 and/or a display module 120 may be implemented in a general computing device 704, a tablet computing device 706 and/or a mobile computing device 708 (e.g., a smart phone). In some aspects, the server 702 is configured to implement an identity module 110, a retrieval module 114, an analysis module 118 and/or a display module 120, via the network 715.

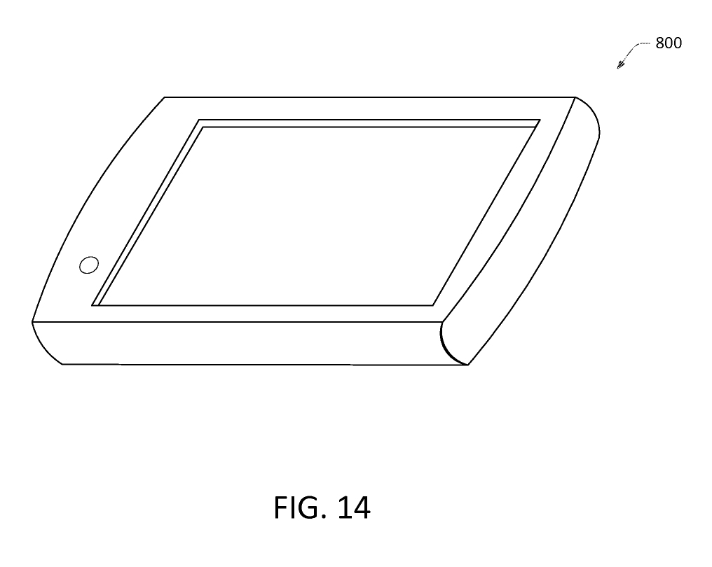

FIG. 14 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

One aspect of the disclosure is directed to a system. The system includes at least one processor and a memory. The memory encodes computer executable instruction that, when executed by the at least one processor, cause the at least one processor to perform a method for creating a unified list of relevant documents. The method includes retrieving from an identity cache a plurality of identities accessible by a user. The method further includes accessing a first file hosting service associated with a first identity in the plurality of identities utilizing the first identity and accessing a second file hosting service associated with a second identity in the plurality of identities utilizing the second identity. The method also includes retrieving first documents from the first file hosting service, retrieving second documents from the second file hosting service, and retrieving third documents form a local drive on the system. Further, the method includes analyzing the first documents, the second documents, and the third documents for relevance to find relevant documents and creating the unified list of relevant documents from the first documents, the second documents, and the third documents based on the relevant documents. Additionally, the method includes displaying the unified list of relevant documents to the user in a first location.

Another aspect of the disclosure includes a system. The system includes an identity system, a retrieval system, an analysis system, and a display system. The identity system retrieves from an identity cache a plurality of identities accessible by a user and accesses a plurality of file hosting service utilizing the plurality of identities. Each file hosting service is associated with at least one identity in the plurality of identities. The retrieval system retrieves first documents from the plurality of file hosting service and retrieves second documents from a local drive on the system. The analysis system analyzes the first documents and the second documents for relevance to find relevant documents and creates a unified list of relevant documents from the first documents and the second documents based on the relevant documents. The displays the unified list of relevant documents to the user in a first location.

Yet another aspect of the disclosure includes a method for creating a unified list. The method includes accessing a plurality of file hosting services utilizing a plurality of identities of a user and aggregating a plurality of documents from each of the plurality of file hosting services and from a local drive on a system to create a combined list of documents. Each file hosting service is associated with at least one identity in the plurality of identities. The method further includes analyzing the combined list to locate relevant documents, creating a unified list that includes the relevant documents, and displaying the unified list in a first location on a user interface. Additionally, the method includes providing a sort option for sorting the unified list and providing a search option for searching the unified list for at least one document. The sort option including a plurality of views.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some aspects of the present technology with reference to the accompanying drawings, in which only some of the possible aspects were described. Other aspects can, however, be embodied in many different forms and the specific aspects disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various aspects disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context creating a unified list that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

1. A system comprising:
at least one processor; and
a memory encoding computer executable instruction that, when executed by the at least one processor, cause the at least one processor to perform a method for creating a unified list of relevant documents, the method comprising:
retrieving from an identity cache a plurality of identities accessible by a user;
accessing a first file hosting service associated with a first identity in the plurality of identities utilizing the first identity;
retrieving first documents from the first file hosting service;
accessing a second file hosting service associated with a second identity in the plurality of identities utilizing the second identity;
retrieving second documents from the second file hosting service;
retrieving third documents form a local drive on the system;
analyzing the first documents, the second documents, and the third documents for relevance to find relevant documents;
creating the unified list of relevant documents from the first documents, the second documents, and the third documents based on the relevant documents; and
displaying the unified list of relevant documents to the user in a first location.

2. The system of claim 1, further comprising:
sorting the unified list of relevant documents according to a received sort selection in a sort option, the sort option including a plurality of views.

3. The system of claim 2, wherein the received sort selection includes a most recently used, a pinned, a file location, a specific file location, an author, a specific author, a title, a modification date, a last edited by, a shared, email attachments, an application, a specific application, a meeting, relevance, and a presented selection.

4. The system of claim 1, further comprising:
searching the unified list of relevant documents for at least one document utilizing text received from the user in a search option.

5. The system of claim 1, wherein the system is a user device, and wherein the user device is at least one of:
a mobile telephone;
a smart phone;
a tablet;
a phablet;
a smart watch;
a wearable computer;
a personal computer;
a desktop computer;
a gaming system; or
a laptop computer.

6. The system of claim 1, wherein the first file hosting service is different than the second file hosting service.

7. The system of claim 1, wherein the relevance is determined based on a user time stamp and a pin status of the first documents, the second documents, and the third documents.

8. The system of claim 7, wherein the relevance is further determined based on current trending documents, documents most recently provided but not accessed by the user, calendar information of the user, and a previous unified document list.

9. The system of claim 1, wherein the relevant documents are from at least one specific application, the at least one specific application is at least one of:
a digital assistant application;
a voice recognition application;
an email application;
a social networking application;
a collaboration application;
an enterprise management application;
a messaging application;
a word processing application;
a spreadsheet application;
a database application;
a presentation application;
a contacts application;
a gaming application;
an e-commerce application;
an e-business application;
a transactional application;
an exchange application; or
a calendaring application.

10. The system of claim 1, further comprising:
accessing a third file hosting service associated with a third identity in the plurality of identities utilizing the third identity;
retrieving fourth documents from the third file hosting service; and
analyzing the fourth documents for the relevance,
wherein the creating the unified list of relevant documents from the first documents, the second documents, and the third documents based on the analyzing of the first documents, the second documents, and the third documents further comprises creating the unified list of relevant documents from the fourth documents based on the analyzing of the fourth documents.

11. The system of claim 1, further comprising:
accessing the first file hosting service associated with a fourth identity in the plurality of identities utilizing the fourth identity;
retrieving fourth documents from the first file hosting service; and
analyzing the fourth documents for the relevance,
wherein the creating the unified list of relevant documents from the first documents, the second documents, and the third documents based on the analyzing of the first documents, the second documents, and the third documents further comprises creating the unified list of relevant documents from the fourth documents based on the analyzing of the fourth documents.

12. A system comprising:
an identity system, the identity system retrieves from an identity cache a plurality of identities accessible by a user and accesses a plurality of file hosting service utilizing the plurality of identities, wherein each file hosting service is associated with at least one identity in the plurality of identities;
a retrieval system, the retrieval system retrieves first documents from the plurality of file hosting service and retrieves second documents from a local drive on the system;
an analysis system, the analysis system analyzes the first documents and the second documents for relevance to find relevant documents and creates a unified list of relevant documents from the first documents and the second documents based on the relevant documents; and
a display system, the display system displays the unified list of relevant documents to the user in a first location.

13. The system of claim 12, further comprising:
a sort system, wherein the sort system sorts the unified list of relevant documents according to a received sort selection in a sort option, the sort option including a most recently used, a pinned, a file location, a specific file location, an author, a specific author, a title, a modification date, a last edited by, a shared, email attachments, an application, a specific application, a meeting, relevance, and a presented selection.

14. The system of claim 13, further comprising:
a search system, the search system provides a search option for searching the unified list of relevant documents for at least one document utilizing text received from the user.

15. The system of claim 12, wherein the system is at least one of:
a mobile telephone;
a smart phone;
a tablet;
a phablet;
a smart watch;
a wearable computer;
a personal computer;
a desktop computer;
a gaming system; or
a laptop computer.

16. The system of claim 12, wherein the relevance is determined based on a last person time stamp and a pin status of the first documents and the second documents.

17. The system of claim 16, wherein the relevance is further determined based on current trending documents, documents most recently provided but not accessed by the user, calendar information of the user, and a previous unified document list.

18. The system of claim 12, wherein the display system also displays the unified list of relevant documents to the user in a second location,
wherein the first location is a start page that is displayed upon logging into the system, and
wherein the second location is at an open document menu option within a specific application.

19. The system of claim 12, wherein the relevant documents are from at least one specific application, the at least one specific application is at least one of:
a digital assistant application;
a voice recognition application;
an email application;
a social networking application;
a collaboration application;
an enterprise management application;
a messaging application;
a word processing application;
a spreadsheet application;
a database application;
a presentation application;
a contacts application;
a gaming application;
an e-commerce application;
an e-business application;
a transactional application;
an exchange application; or
a calendaring application.

20. A method for creating a unified list, the method comprising:
accessing a plurality of file hosting services utilizing a plurality of identities of a user, wherein each file hosting service is associated with at least one identity in the plurality of identities;
aggregating a plurality of documents from each of the plurality of file hosting services and from a local drive on a system to create a combined list of documents;
analyzing the combined list to locate relevant documents;
creating a unified list that includes the relevant documents;
displaying the unified list in a first location on a user interface;
providing a sort option for sorting the unified list, the sort option including a plurality of views; and
providing a search option for searching the unified list for at least one document.
